(19) United States
(12) Patent Application Publication
(10) Pub. No.: US 2002/0117594 A1
(43) Pub. Date: Aug. 29, 2002

(54) Attachment stand frame for spa umbrella

(76) Inventors: Wanda Yiing Li, Irvine, CA (US); Raymond J. Carabotta, Miami, FL (US)

Correspondence Address: Raymond Yat Chan, 1050 Oakdale Lane, Arcadia, CA, 91006-2222, US

(21) Appl. No.: 09/793,268

(22) Filed: Feb. 27, 2001

(51) Int. Cl. F16M 13/00

(52) U.S. Cl. 248/522

(57) ABSTRACT

An attachment stand frame for spa umbrella which includes a shaft supporting an awning thereon, wherein the attachment stand frame includes a stand base including a reinforcing panel extended therefrom adapted for mounting underneath a spa wherein the spa umbrella is uprightly supported on the stand base, and a supporting frame perpendicularly extended from the stand base for substantially attaching to the spa so as to securely mount the spa umbrella to the spa. The attachment stand frame further includes a base body, having a receiving chamber provided thereon, adapted to support the shaft, a rotor, which is rotatably disposed in the receiving chamber, having a rotor axial socket for inserting the shaft thereinto, and a locking arrangement for locking up the rotation movement of the rotor. Therefore, the attachment stand frame is adapted for rigidly supporting by the spa and rotatably mounting the spa umbrella.

### BACKGROUND OF THE PRESENT INVENTION

1. Field of Invention

The present invention relates to an outdoor umbrella, and more particularly to an attachment stand frame for spa umbrella, wherein the attachment stand frame is adapted for easily attaching to and detaching from an existing spa without altering the original structure thereof.

2. Description of Related Arts

Under strong pressure of daily work, most people like to take a spa for relieving stress. They normally build a spa in their bathroom so that they can enjoy the spa everyday. However, some people enjoy taking the spa in a natural environment such that they may purchase an outdoor spa that can be placed in their yard. Taking a spa in outdoors is one kind of nature cures.

However, one of the major drawbacks of the outdoor spa is that the sunlight may directly irritate a user while he or she is taking the spa. So, the user may usually purchase an outdoor umbrella for shading the sunlight. Since the sunlight falls on the ground keeps changing at the time, it is unreasonable for the user to move the entire outdoor umbrella back and forth to obtain the optimum shading area of the outdoor umbrella. Thus, due to the heavy weight of the outdoor umbrella, which is approximately 50 to 60 bounds, the user especially woman always has difficulty to move the outdoor umbrella. For easily moving, the outdoor umbrella may be reduced its weight so that the user may merely reposition the outdoor umbrella with less effort. However, when a gusty wind hits on outdoor umbrella, the unstable outdoor umbrella may fall down easily and hit any object around it, especially a young child, so as to cause an unwanted injury to the young child.

### SUMMARY OF THE PRESENT INVENTION

A main object of the present invention is to provide an attachment stand frame for spa umbrella wherein the attachment stand frame is adapted for detachably attaching to a spa body easily so as to provide an optimum shading area by an awning of the spa umbrella.

Another object of the present invention is to provide an attachment stand frame for spa umbrella wherein attachment stand frame comprised of lightweight but sturdy structure adequate support the spa umbrella. In other words, the spa umbrella can be reduced its overall weight for easy carriage.

Another object of the present invention is to provide an attachment stand frame for spa umbrella wherein a shaft of the spa umbrella is adapted to be rigidly supported on the attachment stand frame and selectively rotated so as to provide an optimum shading area by an awning of the spa umbrella.

Another object of the present invention is to provide an attachment stand frame for spa umbrella wherein the attachment stand frame is adapted for installing into an existing outdoor spa without altering the original structure of the spa.

Accordingly, in order to accomplish the above objects, the present invention provides an attachment stand frame for spa umbrella which comprises a shaft supporting an awning thereon, wherein the attachment stand frame comprises:

a stand base comprising a reinforcing panel extended therefrom adapted for mounting underneath a spa wherein the spa umbrella is uprightly supported on the stand base; and

a supporting frame perpendicularly extended from the stand base for substantially attaching to the spa so as to securely mount the spa umbrella to the spa.

### BRIEF DESCRIPTION OF THE DRAWINGS

FIG. 1 is a perspective view of an attachment stand frame for spa umbrella according to a preferred embodiment of the present invention.

FIG. 2 is a sectional view of the attachment stand frame for spa umbrella according to the above preferred embodiment of the present invention.

FIG. 3 is an exploded perspective view of the attachment stand frame for spa umbrella according to the above preferred embodiment of the present invention.

FIG. 4 illustrates an alternative mode of the supporting frame of the attachment stand frame for spa umbrella according to the above preferred embodiment of the present invention.

### DETAILED DESCRIPTION OF THE PREFERRED EMBODIMENT

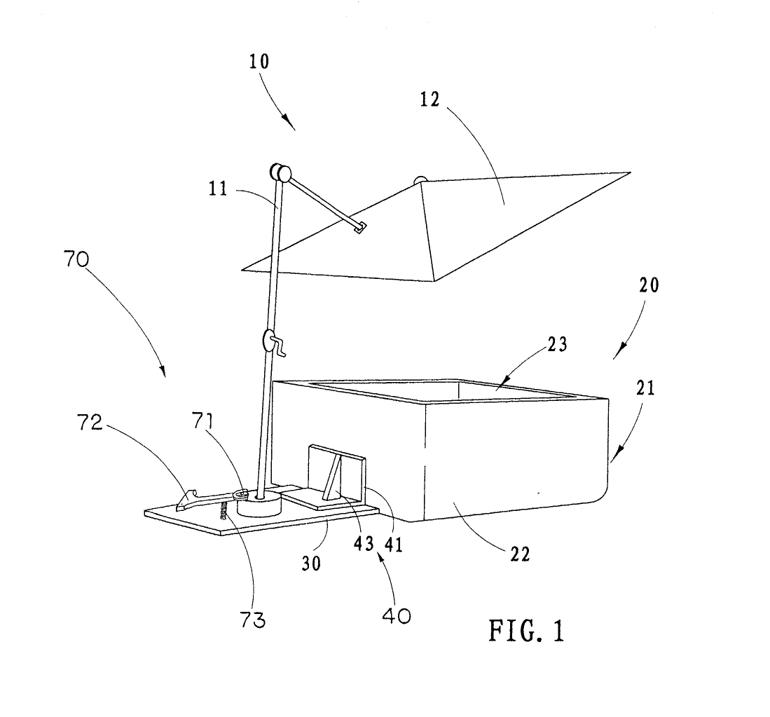

Referring to FIG. 1 of the drawings, an attachment stand frame for spa umbrella according to a preferred embodiment of the present invention, wherein the attachment stand is adapted for rigidly supporting the spa umbrella thereon and substantially mounted the spa umbrella to a spa so as to prevent an unwanted movement of the spa umbrella.

The spa umbrella 10, such as a conventional outdoor umbrella, comprises a shaft 11 supporting an awning 12 thereon wherein the awning 12 is arranged to be rotatably driven by the shaft 11 so as to provide a shading area.

The outdoor spa 20 comprises a spa body 21 having a supporting wall 22 perpendicularly extended therefrom and defining a liquid compartment 23 in the spa body 21. The spa body 21 can be formed in circular shape wherein the supporting wall 22 is formed at a circumference of the spa body 21. Or, the spa body can be formed in rectangular shape wherein four supporting walls 22 are upwardly extended to define the liquid compartment 23 within the supporting walls 22.

According to the preferred embodiment, the attachment stand frame comprises a stand base 30 comprising a reinforcing panel 31 extended therefrom adapted for mounting underneath a spa 20 wherein the spa umbrella 10 is uprightly supported on the stand base 30, and a supporting frame 30 perpendicularly extended from the stand base 30 for substantially attaching to the spa 20 so as to securely mount the spa umbrella 10 to the spa 20.

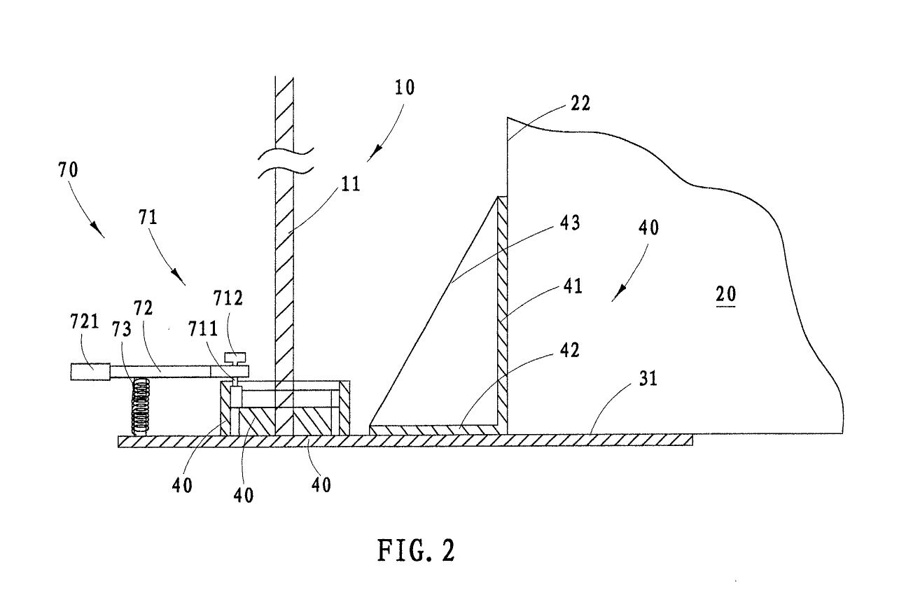

As shown in FIG. 2, the reinforcement panel 31 is integrally extended from the stand base 30 wherein the reinforcement panel 31 having a predetermined thickness is adapted for mounting at a bottom of the spay body 21 of the spa 20 so as to support the spa umbrella 10 in stable manner. Due to the weight of the spa 20, the stand base 30 is depressed by the spa body 21 such that the attachment stand frame is securely mounted on the spa 20 so as to prevent a vertical movement of the spa umbrella 10.

The supporting frame 40 having a L-shaped comprises a vertical panel 41 fittedly attached on the supporting wall 22 of the spa 20 and a horizontal panel 42 mounted on the stand base 30 in such a manner that the supporting frame 40 is rigidly supported on the spa 20 so as to prevent any lateral movement of the spa umbrella 10. In other words, when the attachment stand frame is attached to the spa 20, the spa umbrella 10 is substantially supported by the spa 20 so as to prevent any movement of the spa umbrella 10 by an external force exerted on the spa umbrella 10 such as wind blow.

The supporting frame 40 further comprises a supporting arm 43 inclinedly supported between the vertical panel 41 and horizontal panel 42 so as to form a secure triangular structure for supporting the spa umbrella 10. The triangular shaped supporting arm 43 has a vertical edge portion 431 perpendicularly mounted on the vertical panel 42 and a horizontal edge portion 432 perpendicularly mounted on the horizontal panel 41 of the supporting frame 40 so as to enhance the rigid triangular structure of the attachment stand frame of the present invention.

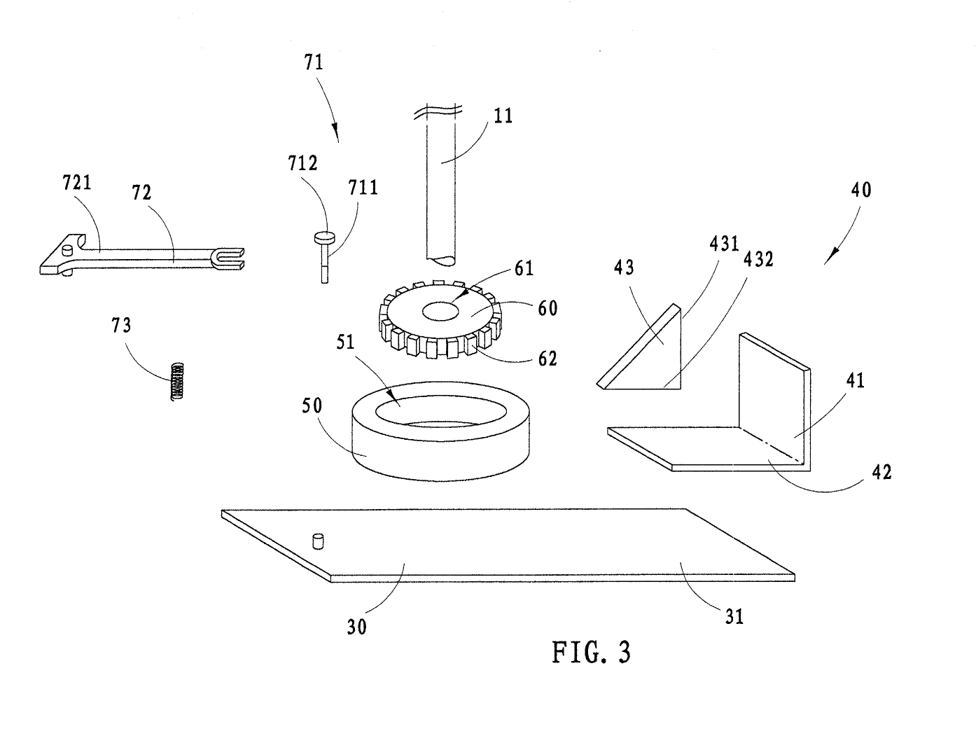

As shown in FIG. 3, the attachment stand frame further comprises a base body 50, which is supported on the stand base 30, having a receiving chamber 51 for uprightly supporting the shaft 11 thereon, a rotor 60, which is rotatably disposed in the receiving chamber 51 of the base body 50, comprising a rotor axial socket 61 for fittedly inserting the shaft 11 thereinto, and a locking arrangement 70 for locking up the shaft 11 on the rotor 60 in a rotatably movable manner.

The locking arrangement 70 comprises a locking member 71 extended into the receiving chamber 51 for engaging with the rotor 60, a driving lever 72 arranged to drive the locking member 71 to move from a locking position to an unlocked position, and a resilient element 73 for applying urging pressure against the driving lever 72 so as to retain the locking member 71 at the locking position. At the locking position, the locking member 71 is engaged with the rotor 60 so as to lock up the rotor 60 from being rotated, and at the unlocked position, the locking member 71 is moved away from the rotor 60 so as to disengage with the rotor 60 such that the rotor 60 is capable of being rotated to turn the shaft 11.

The locking member 71 comprises a locking latch 711 extended into the receiving chamber 51 in a vertical movable manner and an enlarged head button 712 vertically extended from the locking latch 711 to outside, wherein the locking latch 711 is adapted for blocking the rotor 60 in a rotatably movable manner, so as to lock up the rotation of the shaft 11.

The driving lever 72 is pivotally mounted on the base body 50 wherein one engaging end of the driving lever 72 having a Y-shaped is engaged with the locking latch 711 of the locking member 71 while another end of the driving lever 71 has an enlarged step board 721 mounted thereto in such a manner that when a downward force is applied on the step board 721, the locking member 71 is driven to move upwardly to disengage with the rotor 60. In other words, the locking latch 711 is arranged to be driven by the driving lever 72 to move from a normal locking position to an unlocked position.

The resilient element 73 is adapted for applying an urging pressure against the driving lever 72 so as to normally retain the locking member 71 at the locking position. At the locking position, the locking latch 711 of the locking member 71 is extended to the rotor 60 for blocking up the rotor 60 from being rotated in the receiving chamber 51, so as to lock up the rotation of the shaft 11. At the unlocked position, the locking latch 711 of the locking member 71 is vertically moved away from the rotor 60 so as to release the blocking up of the rotor 60, so that the rotor 60 is capable of being rotated to turn the shaft 11.

Accordingly, the resilient element 73 is a coil spring having two ends biasing against the driving lever 72 and the base body 50 so as to normally urge and retain the locking member 71 in a lower position that the locking member 71 is extended to the rotor 60 to block the rotor 60 from being rotated.

Moreover, the rotor 60 comprises a plurality of engaging teeth 62 evenly formed on an outer circumference of the rotor 60 for selectively engaging with the locking member 71, so as to ensure the engagement between the rotor 60 and the locking member 71. In other words, when the locking latch 711 of the locking member 71 is engaged with the engaging teeth 62 of the rotor 60, the rotor 60 is blocked in a rotatably movable manner so as to lock up the rotation of the shaft 11.

In order to mount the attachment stand frame to the spa 20 for supporting spa umbrella 10, the spa body 21 of the spa 20 must be placed on top of the reinforcing panel 31 of the stand base 30 wherein the vertical panel 41 of the supporting frame 40 is pressed against the supporting wall 22 of the spa 20 in such a manner the attachment stand frame is securely attached to the spa 20 and rigidly supported the spa umbrella 20.

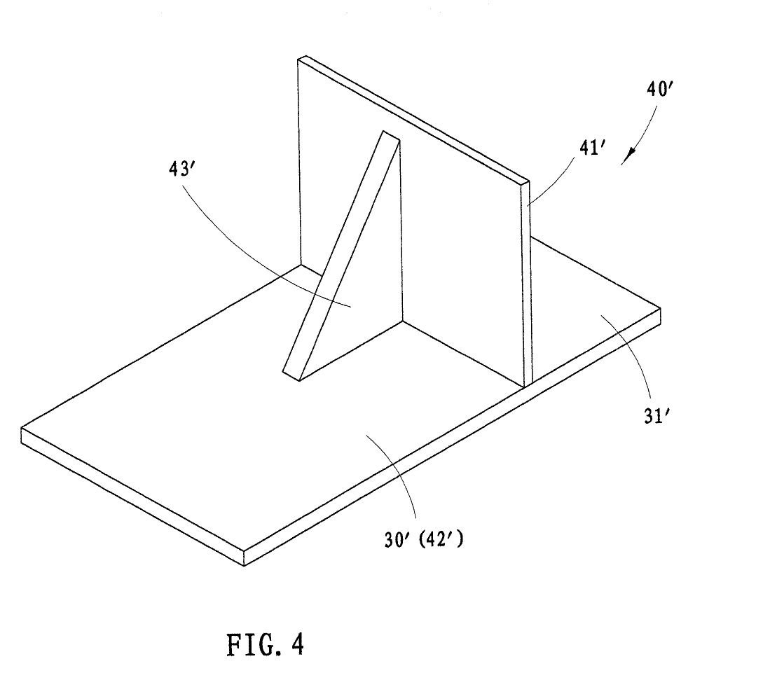

FIG. 4 illustrates an alternative mode of the supporting frame 40′ according to the above preferred embodiment of the present invention, wherein the horizontal panel 42′ of the supporting frame 40′ is the stand base 30′ such that the vertical panel 41′ is integrally extended from the stand base 30′ for rigidly attaching on the supporting wall 22′ of the spa 20′.

What is claimed is:

1. An attachment stand frame for spa umbrella which comprises a shaft supporting an awning thereon, wherein said attachment stand frame comprises:
a stand base comprising a reinforcing panel extended therefrom adapted for mounting underneath a spa wherein said spa umbrella is uprightly supported on said stand base; and
a supporting frame perpendicularly extended from said stand base for substantially attaching to said spa so as to securely mount said spa umbrella to said spa.

2. An attachment stand frame for spa umbrella, as recited in claim 1, further comprising a base body, which is supported on said stand base, having a receiving chamber for uprightly supporting said shaft thereon, a rotor, which is rotatably disposed in said receiving chamber of said base body, comprising a rotor axial socket for fittedly inserting said shaft thereinto, and a locking arrangement for locking up said shaft on said rotor in a rotatably movable manner.

3. An attachment stand frame for spa umbrella, as recited in claim 1, wherein said supporting frame having a L-shaped comprises a vertical panel fittedly attached on a supporting wall of said spa and a horizontal panel mounted on said stand base in such a manner that said supporting frame is adapted for rigidly supporting on said spa.

4. An attachment stand frame for spa umbrella, as recited in claim 2, wherein said supporting frame having a L-shaped comprises a vertical panel fittedly attached on a supporting wall of said spa and a horizontal panel mounted on said stand base in such a manner that said supporting frame is adapted for rigidly supporting on said spa.

5. An attachment stand frame for spa umbrella, as recited in claim 3, wherein said supporting frame further comprises a triangular supporting arm having a vertical edge portion perpendicularly mounted on said vertical panel and a horizontal edge portion perpendicularly mounted on said horizontal panel so as to enhance a rigid triangular structure of said attachment stand frame.

6. An attachment stand frame for spa umbrella, as recited in claim 4, wherein said supporting frame further comprises a triangular supporting arm having a vertical edge portion perpendicularly mounted on said vertical panel of said supporting frame and a horizontal edge portion perpendicularly mounted on said horizontal panel so as to enhance a rigid triangular structure of said attachment stand frame.

7. An attachment stand frame for spa umbrella, as recited in claim 1, wherein said locking arrangement comprises a locking member extended into said receiving chamber for engaging with said rotor, a driving lever arranged to drive said locking member to move from a locking position to an unlocked position, and a resilient element for applying urging pressure against said driving lever so as to retain said locking member at said locking position, wherein at said locking position, said locking member is engaged with said rotor so as to lock up said rotor from being rotated, and at said unlocked position, said locking member is moved away from said rotor so as to disengage with said rotor such that said rotor is capable of being rotated to turn said shaft.

8. An attachment stand frame for spa umbrella, as recited in claim 2, wherein said locking arrangement comprises a locking member extended into said receiving chamber for engaging with said rotor, a driving lever arranged to drive said locking member to move from a locking position to an unlocked position, and a resilient element for applying urging pressure against said driving lever so as to retain said locking member at said locking position, wherein at said locking position, said locking member is engaged with said rotor so as to lock up said rotor from being rotated, and at said unlocked position, said locking member is moved away from said rotor so as to disengage with said rotor such that said rotor is capable of being rotated to turn said shaft.

9. An attachment stand frame for spa umbrella, as recited in claim 4, wherein said locking arrangement comprises a locking member extended into said receiving chamber for engaging with said rotor, a driving lever arranged to drive said locking member to move from a locking position to an unlocked position, and a resilient element for applying urging pressure against said driving lever so as to retain said locking member at said locking position, wherein at said locking position, said locking member is engaged with said rotor so as to lock up said rotor from being rotated, and at said unlocked position, said locking member is moved away from said rotor so as to disengage with said rotor such that said rotor is capable of being rotated to turn said shaft.

10. An attachment stand frame for spa umbrella, as recited in claim 7, wherein said locking arrangement comprises a locking member extended into said receiving chamber for engaging with said rotor, a driving lever arranged to drive said locking member to move from a locking position to an unlocked position, and a resilient element for applying urging pressure against said driving lever so as to retain said locking member at said locking position, wherein at said locking position, said locking member is engaged with said rotor so as to lock up said rotor from being rotated, and at said unlocked position, said locking member is moved away from said rotor so as to disengage with said rotor such that said rotor is capable of being rotated to turn said shaft.

11. An attachment stand frame for spa umbrella, as recited in claim 9, wherein said resilient element is a coil spring having two ends biasing against said driving lever and said base body so as to normally urge and retain said locking member in a lower position that said locking member is extended to said rotor to block said rotor from being rotated.

12. An attachment stand frame for spa umbrella, as recited in claim 10, wherein said resilient element is a coil spring having two ends biasing against said driving lever and said base body so as to normally urge and retain said locking member in a lower position that said locking member is extended to said rotor to block said rotor from being rotated.

13. An attachment stand frame for spa umbrella, as recited in claim 10, wherein said rotor comprises a plurality of engaging teeth evenly formed on an outer circumference of said rotor for selectively engaging with said locking member, so as to ensure an engagement between said rotor and said locking member.

14. An attachment stand frame for spa umbrella, as recited in claim 12, wherein said rotor comprises a plurality of engaging teeth evenly formed on an outer circumference of said rotor for selectively engaging with said locking member, so as to ensure an engagement between said rotor and said locking member.

15. An attachment stand frame for spa umbrella, as recited in claim 3, wherein said horizontal panel of said supporting frame is said stand base such that said vertical panel is integrally extended from said stand base for rigidly attaching on said supporting wall of said spa.

16. An attachment stand frame for spa umbrella, as recited in claim 4, wherein said horizontal panel of said supporting frame is said stand base such that said vertical panel is integrally extended from said stand base for rigidly attaching on said supporting wall of said spa.

17. An attachment stand frame for spa umbrella, as recited in claim 16, wherein said supporting frame further comprises a triangular supporting arm having a vertical edge portion perpendicularly mounted on said vertical panel of said supporting frame and a horizontal edge portion perpendicularly mounted on said stand base so as to enhance a rigid triangular structure of said attachment stand frame.

18. An attachment stand frame for spa umbrella, as recited in claim 17, wherein said locking arrangement comprises a locking member extended into said receiving chamber for engaging with said rotor, a driving lever arranged to drive said locking member to move from a locking position to an unlocked position, and a resilient element for applying urging pressure against said driving lever so as to retain said locking member at said locking position, wherein at said locking position, said locking member is engaged with said rotor so as to lock up said rotor from being rotated, and at said unlocked position, said locking member is moved away from said rotor so as to disengage with said rotor such that said rotor is capable of being rotated to turn said shaft.

19. An attachment stand frame for spa umbrella, as recited in claim 18, wherein said rotor comprises a plurality of engaging teeth evenly formed on an outer circumference of said rotor for selectively engaging with said locking member, so as to ensure an engagement between said rotor and said locking member.

20. An attachment stand frame for spa umbrella, as recited in claim 19, wherein said resilient element is a coil spring having two ends biasing against said driving lever and said base body so as to normally urge and retain said locking member in a lower position that said locking member is extended to said rotor to block said rotor from being rotated.
